(19) United States
(12) Patent Application Publication
(10) Pub. No.: US 2004/0249721 A1
(43) Pub. Date: Dec. 9, 2004

(54) Internet shopping system and combined television/internet system

(75) Inventor: Katsuhiro Morisada, Daito-shi (JP)

Correspondence Address: CROWELL & MORING LLP, INTELLECTUAL PROPERTY GROUP, P.O. BOX 14300, WASHINGTON, DC, 20044-4300, US

(73) Assignee: Funai Electric Co., Ltd.

(21) Appl. No.: 10/760,670

(22) Filed: Jan. 21, 2004

(30) Foreign Application Priority Data
Jan. 22, 2003 (JP) 2003-013929

(51) Int. Cl. G06F 17/60

(52) U.S. Cl. 705/26

(57) ABSTRACT

In response to a request from a user for operation check on a product offered for sale at a shopping site, information equipment such as, for example, a personal computer reads in via the Internet Web instruction manual data in HTML format and vector graphics data each stored in a merchant side Web server, and displays animated Web instruction manual on the display based on the data. Thus, the user can view the animated Web instruction manual to easily understand the operation and usability of the product.

### BACKGROUND OF THE INVENTION

1. Field of the Invention

The present invention relates to an Internet shopping system for buying and selling a product such as, for example, a Digital Versatile Disk (DVD) at a shopping site on the Internet and a method thereof, and further relates to a combined television/Internet system.

2. Description of the Related Art

Internet shopping systems have become popular that allow a user to access a shopping site on the Internet by using information equipment such as a personal computer (referred to as PC, hereinafter), a WebTV, a Personal Digital Assistants (PDA) or the like, and to place a purchase order via the Internet if the user desires to purchase at least one of the products shown on the home page of the site. In such a shopping system, when desiring to check the operation or usability of the product as well as the features and price of the product prior to the purchase, the user generally views a Web instruction manual regarding the product of interest on the home page of the shopping site or on the home page of a site of the maker that manufactured the product.

However, the above conventional Web instruction manual accessible on the home page of, for example, the shopping site is only a copy of the paper instruction manual accompanying the product sold and is displayed as a static image, thus failing to show the operation and usability of the product in a manner allowing the user to understand it without difficulty. In other words, the conventional shopping system is disadvantageous in that the user cannot have an accurate knowledge of the operation and usability of the product, in which the user is interested, by viewing the Web instruction manual, before purchasing the product at the shopping site.

The above-described Web instruction manuals, which are displayed as static images, are disclosed in, for example, Japanese laid-open patent publication No. 2001-351168 showing a Web instruction manual as to a car washing apparatus, Japanese laid-open patent publication No. 2002-197216 showing Web operation and maintenance manuals as to equipment constituting a manufacturing system, and Japanese laid-open patent publication No. HEI 10-179586 showing a Web instruction manual as to an ultrasonic apparatus for use in medical diagnosis.

In the field of electronic manual for setup of equipment, Japanese laid-open patent publication No. HEI 11-53377 discloses that a method of mounting an ink cartridge on a printer is displayed as an animation. In the electronic manual, however, how to handle the product after setup is not shown as an animation.

### SUMMARY OF THE INVENTION

An object of the present invention is to provide an Internet shopping system that allows a user to view a Web instruction manual so as to have an accurate knowledge of the operation and usability of a product, in which the user is interested, before purchasing the product at the shopping site, and a combined television/Internet system.

An aspect of the present invention provides an Internet shopping system for buying and selling a product manufactured by a maker at a shopping site, comprising a maker side Web server supplied to the maker and distributing Web instruction manual data, regarding the product, created by HTML and animation data via the Internet, a merchant side Web server supplied to a merchant buying the product from the maker for sale and connected to the maker side Web server via the Internet, the merchant side Web server having a storage device that stores the Web instruction manual data in HTML format and the animation data each distributed by the maker side Web server, and information equipment supplied to a consumer, of the product offered for sale at the shopping site set up on the merchant side Web server, and connected via the Internet to the maker side Web server and to the merchant side Web server, the information equipment having a display device on which a home page containing the Web instruction manual is displayed.

In response to a request from a user for operation check on the product offered at the shopping site, the information equipment reads in via the Internet the Web instruction manual data in HTML format and the animation data each stored in the merchant side Web server and displays animated Web instruction manual on the display device based on the Web instruction manual data and the animation data, so that the user can view the animated Web instruction manual to easily understand the operation and usability of the product.

By such a configuration, the information equipment can display the animated Web instruction manual on the display device so as to effectively show the operation and usability of the product offered for sale at the shopping site upon receipt of the request from the user for operation check on the product. Therefore, the user can have an accurate knowledge of the operation and usability of the product of interest by viewing the Web instruction manual, before purchasing the product at the shopping site.

Another aspect of the present invention provides a combined television/Internet system comprising a maker side Web server supplied to a maker and distributing Web instruction manual data, regarding a product manufactured by the maker, created by HTML and animation data via the Internet, a merchant side Web server supplied to a merchant buying the product from the maker for sale and connected to the maker side Web server via the Internet, the merchant side Web server having a storage device that stores the Web instruction manual data in HTML format and the animation data each distributed by the maker side Web server, and a television set supplied to a consumer of the product offered for sale at a shopping site set up on the merchant side Web server, the television set having a television connected to an image reproduction apparatus that reproduces images recorded on a recording medium and a set-top box for connection between the television and the Internet.

In response to a request from a user for operation check on the product offered at the shopping site, the television set causes the set-top box to read in via the Internet the Web instruction manual data in HTML format and the animation data each stored in the merchant side Web server and displays animated Web instruction manual on a screen of the television based on the Web instruction manual data and the animation data.

By such a configuration, for example, by connecting the television set to the image reproduction apparatus such as a DVD player, a VTR or the like, the user can view the animated Web instruction manual regarding the image reproduction apparatus on the screen of the television connected thereto. A s a result, the user can easily understand the operation of the apparatus.

### BRIEF DESCRIPTION OF THE DRAWINGS

FIG. 1 is a view showing the configuration of a network system (Internet shopping system) according to the first embodiment of the present invention.

FIG. 2 is a view showing how to transmit animated Web instruction manual data and data in PDF format for printing to information equipment in the network system.

FIG. 3 is a view showing an initial frame of the Web instruction manual.

FIG. 4 is a view showing the first instruction frame, regarding playback operation of a DVD player, in the Web instruction manual.

FIG. 5 is a view showing the second instruction frame, regarding playback operation of the DVD player, in the Web instruction manual.

FIG. 6 is a view showing the third instruction frame, regarding playback operation of the DVD player, in the Web instruction manual.

FIG. 7 is a flowchart showing the steps performed at the Internet shopping using the network system.

FIG. 8 is a view showing the configuration of a WebTV and its peripheral equipment in a network system (combined television/Internet system) according to the second embodiment of the present invention.

### DETAILED DESCRIPTION OF THE PREFERRED EMBODIMENT

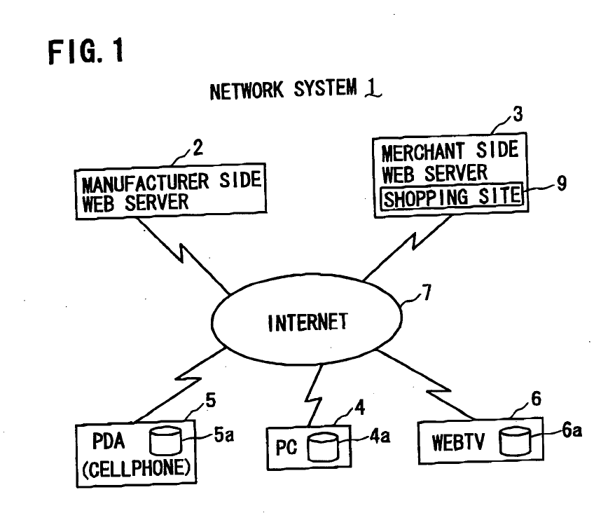

Referring now to the accompanying drawings, preferred embodiments of the present invention will be described. FIG. 1 shows a network system according to the first embodiment of the present invention. This network system 1, which corresponds to the Internet shopping system in claims, includes a maker side Web server 2 that is supplied to a maker manufacturing, for example, a Digital Versatile Disc (DVD) player and distributes Web instruction manual data regarding the product manufactured by the maker, a merchant side Web server 3 supplied to a merchant (or, more generally, seller) that buys the product from the maker for selling it, and a variety of information equipment supplied to a consumer of the product offered for sale at a shopping site 9 set up on the merchant side Web server 3. The information equipment is, more particularly, any of a personal computer (PC) 4, a Personal Digital Assistants (PDA) 5 such as a cellphone or the like, and a WebTV 6. The PC 4 corresponds to the client computer in claims 4 to 6. The maker side Web server 2, the merchant side Web server 3, and the information equipment such as, for example, the PC 4 are connected to each other via the Internet 7. The PC 4, the PDA 5, and the WebTV 6, which are the information equipment, have respective storage devices 4a, 5a, and 6a. Stored in each of the storage devices 4a, 5a, and 6a are a Web browser as a program for display of a home page and a Flash player as a plug-in for displaying an animation on a display via the Web browser.

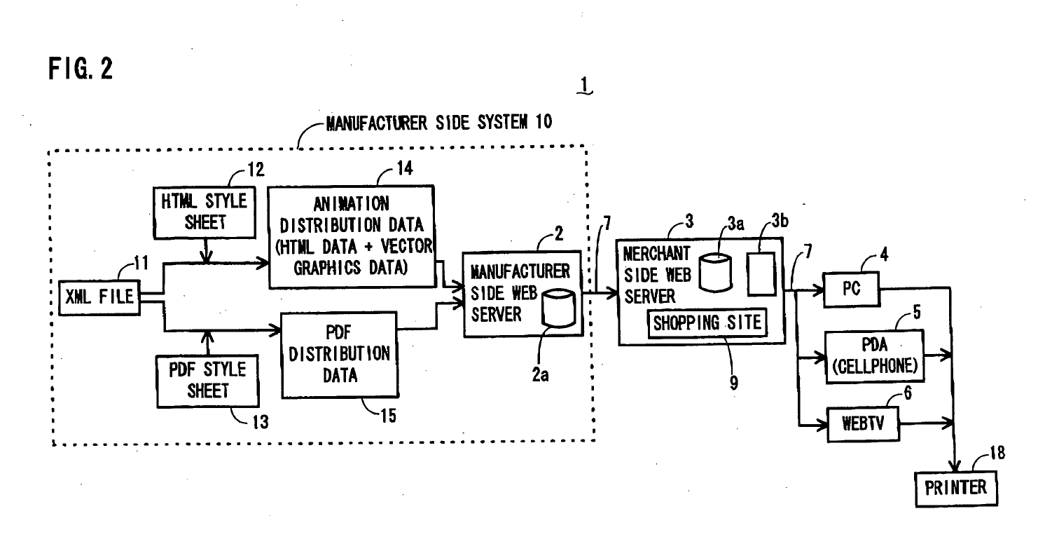

Referring now to FIG. 2, a description will be made as to how to display an animated Web instruction manual on the display of the PC 4 or other information equipment in the above network system 1. A maker side system 10 creates animation distribution data 14 including Web instruction manual data created by Hyper Text Markup Language (HTML) and vector graphics data for displaying the Web instruction manual as an animation, based on an original Web instruction manual data file (referred to as “XML file” hereinafter) 11 that is created by Extensible Markup Language (XML) and a style sheet (HTML style sheet) 12 for defining the layout of HTML format. The maker side system 10 further creates Web instruction manual distribution data in PDF format (PDF distribution data) 15, based on the XML file 11 and a style sheet (PDF style sheet) 13 for defining the layout of PDF format. Then, the maker side system 10 stores the animation distribution data 14 and the PDF distribution data 15 in a storage device 2a within the maker side Web server 2. After the distribution data 14 and 15 are completely stored in the storage device 2a, the maker side Web server 2 transmits the distribution data 14 and 15 to the merchant side Web server 3 via the Internet 7. Upon receipt of the animation distribution data 14 and the PDF distribution data 15 from the maker side Web server 2 by means of a communication portion 3b (receiver and transmitter), the merchant side Web server 3 stores the distribution data 14 and 15 in a storage device 3a therein.

When starting up, the PC 4 or other information equipment reads the Web browser and the Flash player each stored on, for example, the storage device 4a into the memory. Then, in response to a request from a user for operation check on a product offered for sale at the shopping site 9 on the merchant side Web server 3, the PC 4 or other information equipment transmits a request to the merchant side Web server 3 to transmit the animation distribution data 14 for operation check on the product. Upon receipt of the request, the merchant side Web server 3 transmits the required animation distribution data 14 via the communication portion 3b. Upon receipt of the animation distribution data 14, the PC 4 or other information equipment displays the animated Web instruction manual on the display via the Web browser and the Flash player, based on the animation distribution data 14. Meanwhile, in response to a request from the user to print the instruction manual about the product offered for sale at the shopping site 9, the PC 4 or other information equipment transmits a request to the merchant side Web server 3 to transmit the instruction manual data in PDF format. Upon receipt of the request, the merchant side Web server 3 transmits the required instruction manual data via the communication portion 3b. Upon receipt of the instruction manual data in PDF format, the PC 4 or other information equipment causes a printer 18 shown in FIG. 2 to print the instruction manual data. Thus, the user can check the features and functions of the product of interest on the printed instruction manual before purchasing the product at the shopping site 9.

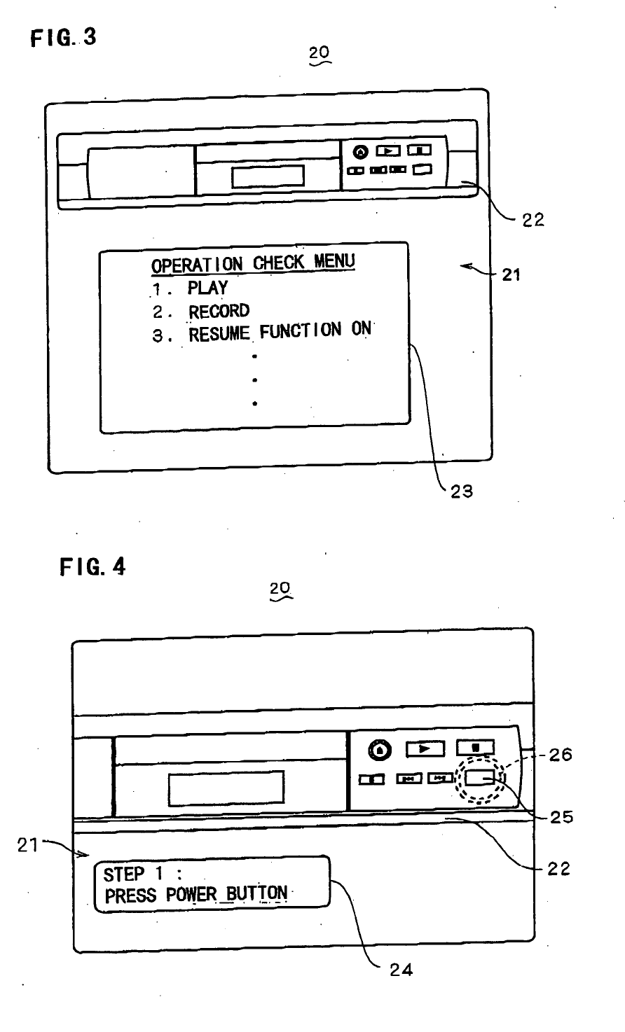

Referring now to FIGS. 3 to 6, a description will be made as to the animated Web instruction manual that is displayed on the display of the PC 4 or other information equipment. FIGS. 3 to 6 illustrate a Web instruction manual 21 in the case where the product of which the operation check is required by the user is a DVD player. In response to a request from the user for operation check on the DVD player offered for sale at the shopping site 9, the PC 4 or other information equipment displays on a display 20 (display device in claim 3) the initial frame of the Web instruction manual 21 as shown in FIG. 3. In the initial frame of the Web instruction manual 21, an image 22 of the DVD player as the object of the operation check is displayed together with an operation check menu 23 regarding the DVD player. If the user selects “1. Play” from the menu 23 in order to check the playback operation of the DVD player, the PC 4 or other information equipment displays, as shown in FIG. 4, a message 24 “Step 1 Press POWER button.” with an instruction circle 26 appearing around the POWER button 25 on the screen. Thus, the user is prompted to depress the POWER button 25. The instruction circle 26 is shown by orange blinking light for calling the user's attention.

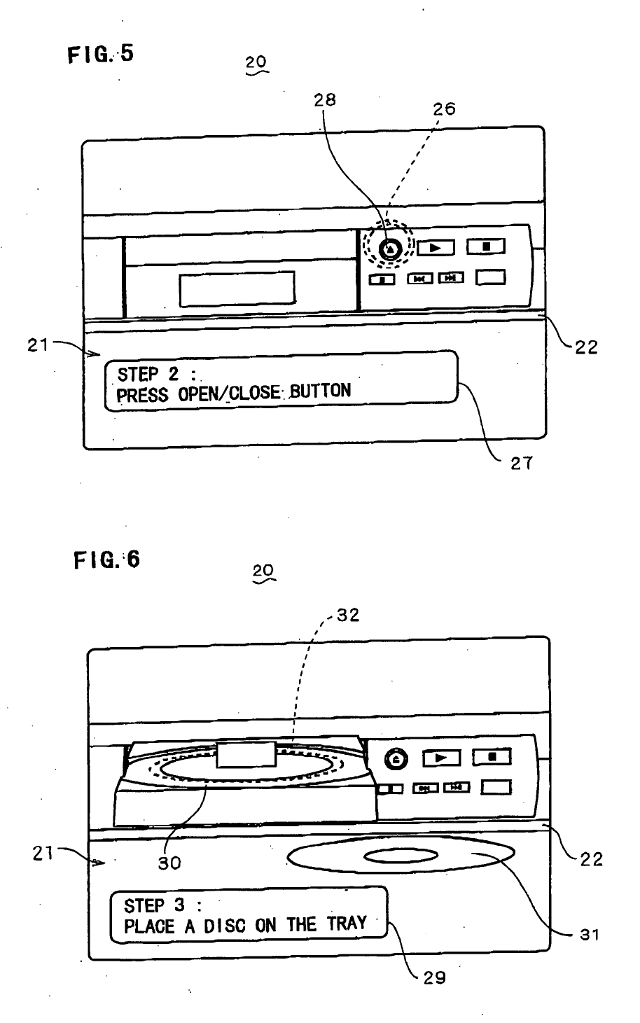

In the state shown in FIG. 4, the user clicks on the POWER button 25 surrounded by the instruction circle 26 using a pointing device such as, for example, a mouse. Then, the PC 4 or other information equipment displays, as shown in FIG. 5, a message 27 “Step 2 Press OPEN/CLOSE button.” with the instruction circle 26 appearing around the OPEN/CLOSE button 28 on the screen. Thus, the user is prompted to depress the OPEN/CLOSE button 28.

Next, in the state shown in FIG. 5, the user clicks on the OPEN/CLOSE button 28 surrounded by the instruction circle 26 using the pointing device. Then, the PC 4 or other information equipment displays, as shown in FIG. 6, a message 29 “Step 3 Place a disc on the tray.” with an instruction area 32 appearing on the tray 30 on the screen at the position where an DVD 31 is placed. Thus, the user is prompted to place the DVD 31 on the tray 30 in the predetermined position. The instruction area 32 is elliptical in shape and shown by orange blinking light for calling the user's attention in the similar manner as in the instruction circle 26.

As described above, the PC 4 or other information equipment in this embodiment displays the animated Web instruction manual 21 on the display 20 for showing how to handle the product and how the product works so that they can be easily understood by the user. Therefore, the user can have an accurate knowledge of the operation and usability of the product, in which the user is interested, by viewing the Web instruction manual 21 before the purchase of the product at the shopping site 9.

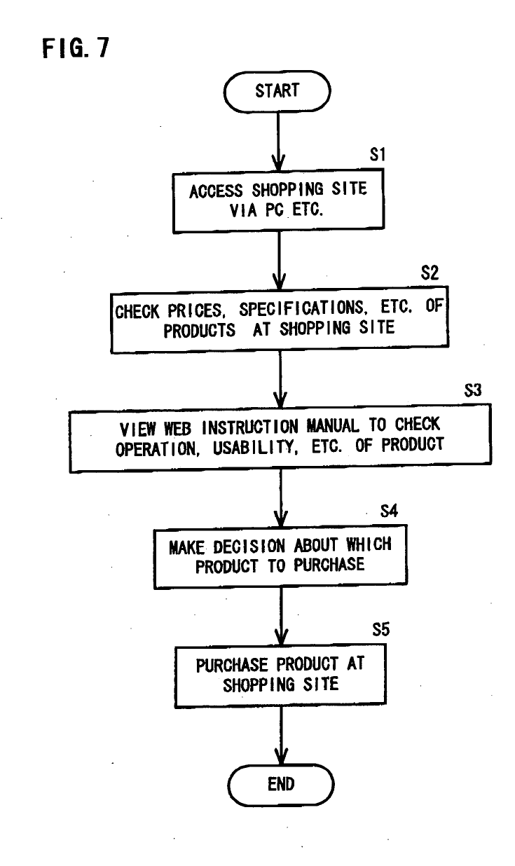

FIG. 7 shows the steps performed at the Internet shopping using the network system 1. The user, who plans to purchase a product offered for sale at the shopping site 9 on the merchant side Web server 3, accesses the shopping site 9 via the PC 4 or other information equipment (S1), views the home page on the shopping site 9 to check the prices, features, and so on of the products offered for sale at the site 9 (S2), and then selects one or more products of interest to the user. Next, the user accesses the merchant side Web server 3 via the PC 4 or other information equipment, so that the animated Web instruction manual 21 is displayed on the display 20 of the PC 4 or other information equipment. The user views the Web instruction manual 21 to check the operation, usability, and so on of the product in which the user is interested (S3), makes a decision about which product to purchase (S4), and then purchases the product at the shopping site 9 via electronic commerce (S5).

As described above, the network system 1 according to the first embodiment causes the PC 4 or other information equipment to, in response to a request from the user for operation check on the product offered at the shopping site 9, display the animated Web instruction manual 21 on the display 20 based on the Web instruction manual data in HTML format and the vector graphics data, thus showing the operation and usability of the product such that they can be easily understood. Therefore, the user can have an accurate knowledge of the operation and usability of the product of interest by viewing the Web instruction manual 21 prior to the purchase at the shopping site 9. Further, if an error is found in the Web instruction manual 21, the maker side Web server 2 can transmit an error-corrected Web instruction manual data to the merchant side Web server 3, from which the PC 4 or other information equipment can read in the error-corrected Web instruction manual 21 for display, in response to a request from the user for operation check on the product.

The following are benefits arising from using the Web instruction manual 21 rather than paper one as the instruction manual of the product offered for sale at the shopping site 9. First, the paper instruction manual attached to the product can considerably decrease in number of pages for cost reduction. For example, if the product is a DVD player, the number of pages of the paper instruction manual attached thereto can be decreased from about 30-40 to about 4. Second, the Web instruction manual 21 allows an addition of, for example, Q&A to be performed promptly, in contrast to the paper instruction manual.

Now, a network system 1 according to the second embodiment of the present invention will be described. This network system 1, which corresponds to the combined television/Internet system in claim 11, includes a maker side Web server 2, a merchant side Web server 3, a WebTV 6, and the Internet 7, which are similar to those shown in FIG. 1. The WebTV 6 is connected to an image reproduction apparatus such as, for example, a DVD player. Each of the maker side Web server 2 and the merchant side Web server 3 stores Web instruction manual data in HTML format and animation data, like those in the network system 1 according to the first embodiment.

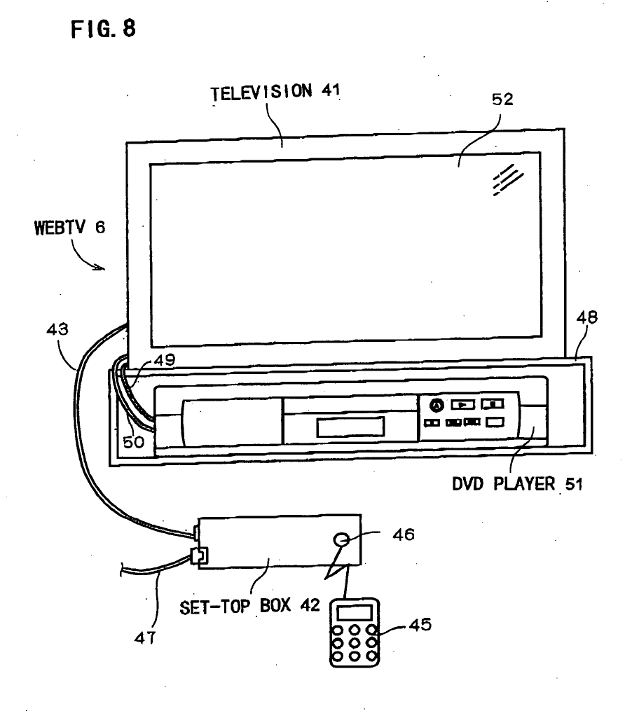

FIG. 8 shows the configuration of the WebTV 6 and its peripheral equipment, with a DVD player as the image reproduction apparatus connected to the WebTV 6. The WebTV 6 includes a television 41 and a set-top box 42 for connecting the television 41 to the Internet 7. The television 41 and the set-top box 42 are connected to each other via a video cable 43 for transmission of video signals and an audio cable 44 for transmission of audio signals. As shown in FIG. 8, the set-top box 42 has an infrared signal receiver 46 that receives infrared signals from a remote control unit 45 and is connected to a telephone line via a modular jack 47. The television 41 is connected to the DVD player 51 housed in a cabinet 48 via a video cable 49 for video signal transmission and an audio cable 50 for audio signal transmission.

In order to review the operation of the already purchased DVD player 51 using the WebTV 6, the user accesses via the set-top box 42 the shopping site 9 of the merchant from which the DVD player 51 is purchased, and directs the set-top box 42 to display animated Web instruction manual 21 using the remote control unit 45. Upon receipt of the command signal from the remote control unit 45, the set-top box 42 reads in via the Internet 7 distribution data 14 (see FIG. 2) including the Web instruction manual data in HTML format and the animation data each stored in the merchant side Web server 3 and displays the animated Web instruction manual 21 on a screen 52 of the television 41 based on the distribution data 14. Thus, the user can view the animated Web instruction manual 21 regarding the DVD player 51 on the screen 52 of the television 41 that is used for display of images output from the DVD player 51.

The present invention is not to be limited by the above described embodiments, but various modifications may be made without departing from the spirit and scope of the invention. For example, in the first embodiment, the product to be purchased by the user at the shopping site 9 is not limited to the DVD player 51 but may be any other product. In the second embodiment, the image reproduction apparatus connected to the WebTV 6 is not limited to the DVD player 51 but may be a Video Tape Recorder (VTR) or the like. In the first and second embodiments, the Flash player as the plug-in for display of the animated Web instruction manual may be replaced with another software such as, for example, Shockwave. Further, in the first and second embodiments, the animated Web instruction manual may be displayed on the display of the PC 4 or other information equipment based on animation distribution data stored in the maker side Web server rather than on the animation distribution data 14 stored in the merchant side web server 3.

What is claimed is:

1. An Internet shopping system for buying and selling a product manufactured by a maker at a shopping site, comprising:
a maker side Web server supplied to the maker and distributing Web instruction manual data, regarding the product, created by HTML and animation data via the Internet;
a merchant side Web server supplied to a merchant buying the product from the maker for sale and connected to the maker side Web server via the Internet, the merchant side Web server having a storage device that stores the Web instruction manual data in HTML format and the animation data each distributed by the maker side Web server; and
information equipment supplied to a consumer, of the product offered for sale at the shopping site set up on the merchant side Web server, and connected via the Internet to the maker side Web server and to the merchant side Web server, the information equipment having a display device on which a home page containing the Web instruction manual is displayed,
wherein, in response to a request from a user for operation check on the product offered at the shopping site, the information equipment reads in via the Internet the Web instruction manual data in HTML format and the animation data each stored in the merchant side Web server and displays animated Web instruction manual on the display device based on the Web instruction manual data and the animation data, so that the user can view the animated Web instruction manual to easily understand the operation and usability of the product.

2. The Internet shopping system according to claim 1,
wherein the information equipment further includes an information equipment side storage device that stores a Web browser as a program for display of the home page containing the Web instruction manual and a plug-in for display of animation on the display device via the Web browser; and
wherein, when starting up, the information equipment reads the Web browser and the plug-in stored in the information equipment side storage device, and in response to the request from the user for operation check on the product offered at the shopping site, the information equipment displays the animated Web instruction manual on the display device via the Web browser and the plug-in based on the Web instruction manual data in HTML format and vector graphics data as the animation data, each of which is read from the merchant side Web server.

3. An Internet shopping system for buying and selling a product manufactured by a maker at a shopping site, comprising:
a maker side Web server supplied to the maker and having a storage device that stores Web instruction manual data, regarding the product, created by HTML and animation data, the maker side Web server distributing the Web instruction manual data and the animation data via the Internet; and
information equipment supplied to a consumer, of the product offered for sale at the shopping site set up on the maker side Web server, and connected to the maker side Web server via the Internet, the information equipment having a display device for display of a home page containing the Web instruction manual,
wherein, in response to a request from a user for operation check on the product offered at the shopping site, the information equipment reads in via the Internet the Web instruction manual data in HTML format and the animation data each stored in the maker side Web server and displays animated Web instruction manual on the display device based on the Web instruction manual data and the animation data, so that the user can view the animated Web instruction manual to easily understand the operation and usability of the product.

4. The Internet shopping system according to claim 1, wherein the information equipment is a client computer.

5. The Internet shopping system according to claim 2, wherein the information equipment is a client computer.

6. The Internet shopping system according to claim 3, wherein the information equipment is a client computer.

7. The Internet shopping system according to claim 1, wherein the information equipment is a personal digital assistant.

8. The Internet shopping system according to claim 2, wherein the information equipment is a personal digital assistant.

9. The Internet shopping system according to claim 3, wherein the information equipment is a personal digital assistant.

10. A merchant side Web server supplied to a merchant of a product manufactured by a maker, comprising:
a receiver that receives via the Internet Web instruction manual data, regarding the product, created by HTML and animation data from a maker side Web server supplied to the maker;
a storage device that stores the Web instruction manual data and the animation data each received by the receiver; and
a transmitter that, in response to a request, from information equipment supplied to a consumer of the product offered for sale at a shopping site set up on the merchant side Web server, to transmit operation information on the product offered at the shopping site, transmits the Web instruction manual data in HTML format and the animation data, each stored in the storage device, to the information equipment via the Internet.

11. A combined television/Internet system comprising:
a maker side Web server supplied to a maker and distributing Web instruction manual data, regarding a product manufactured by the maker, created by HTML and animation data via the Internet;
a merchant side Web server supplied to a merchant buying the product from the maker for sale and connected to the maker side Web server via the Internet, the merchant side Web server having a storage device that stores the Web instruction manual data in HTML format and the animation data each distributed by the maker side Web server; and
a WebTV supplied to a consumer of the product offered for sale at a shopping site set up on the merchant side Web server, the WebTV having a television connected to an image reproduction apparatus that reproduces images recorded on a recording medium and a set-top box for connection between the television and the Internet,
wherein, in response to a request from a user for operation check on the product offered at the shopping site, the television set causes the set-top box to read in via the Internet the Web instruction manual data in HTML format and the animation data each stored in the merchant side Web server and displays animated Web instruction manual on a screen of the television based on the Web instruction manual data and the animation data.
